(19) United States
(12) Patent Application Publication
(10) Pub. No.: US 2011/0131218 A1
(43) Pub. Date: Jun. 2, 2011

(54) Dynamic Content Sorting Using Tags

(76) Inventors: Jason D. Goldman, Ft. Collins, CO (US); James Louis Long, Fort Collins, CO (US)

(21) Appl. No.: 13/058,343

(22) PCT Filed: Oct. 14, 2008
(86) PCT No.: PCT/US08/79884

§ 371 Date: Feb. 10, 2011

(51) Int. Cl. G06F 17/30

(52) U.S. Cl. 707/752; 707/736; 707/769; 707/E17.005; 707/E17.014

(57) ABSTRACT

A data processing system facilitates organization of content such as digital photographs, video files, audio tracks, and the like. The data processing system comprises a content manager that manages a content database and includes a content database initialization or creation utility and a content database search utility. The a content database initialization utility creates a content database by assigning one or more tags that represents context of the content to content and combines the tag or tags with associated content in a data structure, and saves the data structure in a database. The content database search utility specifies a set of tag values representing context of content and initiates a database query for determining a set of content items that match the specified set of tag values. The content database search utility searches for the set of content items that match the tag values.

### BACKGROUND

In a digital photography system, users may collect a large number of image files on a computer. Photograph management software allows users to create photograph albums to organize their pictures, usually as part of a process for uploading photographs from the camera. The software also allows the user to manually place a photograph into multiple albums. The photograph albums are static in the sense that the album exists in the form of manually created entities to which the user explicitly adds photographs. Since the only way for a photograph to be added to the album is via manual action of the user, the process of photo album management is inherently time-consuming. Users generally must browse to the photographs during sorting. The user typically views a list of possible albums for insertion of the pictures and manually places the photographs into the desired albums.

A user creating a new photograph album may typically have to browse through all existing pictures to find pictures that are appropriate or desirable for the new album, making difficult the creation of transient collections of photographs.

Two common ways for organizing image files for viewing and accessing are through usage of file system artifacts such as folders and digital photo albums in the form of collections of photographs. Often digital photo albums are directly mapped from file system folders. Typically a file system is used to organize albums, with one directory representing one album. To place a photograph into an album, an associated media file is copied into the album directory.

A user includes an image in multiple albums by duplicating image files in the file system. Images are typically organized into albums which are similar to Personal Computer (PC) files system folders. Thus, an image copy resides in only one album and duplicate copies are used to store the image in multiple albums. For example, content is commonly organized into discrete collections of albums. To include a single content item into multiple albums, a file is copied into multiple album folders. Organizing the image files is generally a manual process.

In either conventional technique for photograph organization, photo albums and folders are static entities so that individual files and photographs are handled independently of other files and photographs, regardless of duplication. Thus, older photos may be ignored or forgotten when a user creates a new album.

Digital cameras typically integrate with computers by using software that allows uploading of photographs into file system folders and creating related photo albums. For example, many digital cameras are supplied in combination with photograph management software. The management software enables simple uploading of new photographs into a new photo album or directory. Users can also create new photo albums and manually move or copy photos into the new album, a time consuming process that involves the usual burdens and error-susceptibility of a manual process. Older photos that may fit into a new album are often ignored or forgotten.

### SUMMARY

Embodiments of a data processing system facilitate organization of content such as digital photographs, video files, audio tracks, and the like. The data processing system comprises a content manager that manages a content database and includes a content database initialization or creation utility and a content database search utility. The content database initialization utility creates a content database by assigning one or more tags that represents context of the content to content and combines the tag or tags with associated content in a data structure, and saves the data structure in a database. The content database search utility specifies a set of tag values representing context of content and initiates a database query for determining a set of content items that match the specified set of tag values. The content database search utility searches for the set of content items that match the tag values.

### BRIEF DESCRIPTION OF THE DRAWINGS

Embodiments of the invention relating to both structure and method of operation may best be understood by referring to the following description and accompanying drawings:

FIG. 1 is a schematic block diagram showing an embodiment of a data processing system that facilitates organization of content;

FIG. 2 is a schematic block diagram depicting an embodiment of a network system that supports content organization;

FIGS. 3A through 3G are flow charts illustrating one or more embodiments or aspects of a computer-executed method for managing content;

FIG. 4 is a flow chart showing an embodiment or aspect of a computer-executed method for managing content; and

FIG. 5 is a schematic block diagram depicting an embodiment of a photograph management system that enables sorting of digital photographs using dynamic tags.

### DETAILED DESCRIPTION

Media content such as photographs are sorted using dynamic tags.

Users with a large collection of photographs appreciate an efficient technique for organization. Illustrative systems and techniques enable users to dynamically associate tags with photographs. The tags can be pre-defined or user-selected. Photographs may be organized in multiple ways based on associated tag values.

As digital photography increases in popularity, users often collect a large number of digital photographs. The systems and techniques disclosed herein enable users to organize their photographs in meaningful ways. A user may want to arrange the same photograph in different contexts. For example, a family picture may fit into both a “family pictures” photograph album and a “family reunion 2005” album. Manual organization of photographs is time consuming when done at the time the photographs are uploaded. The user is often creating a new album and may add the photographs to previously existing albums. The process is even more time consuming if the user later decides to organize older photographs in a new way, for example by creating new photograph albums.

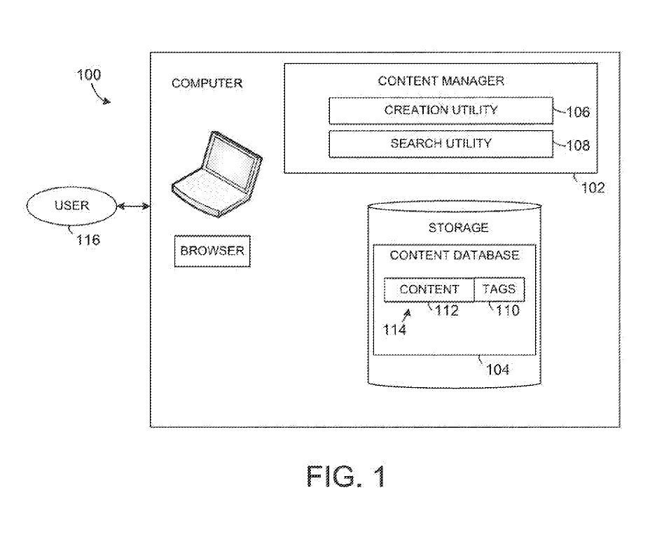

Referring to FIG. 1, a schematic block diagram illustrates an embodiment of a data processing system 100 that facilitates organization of content such as digital photographs, video files, audio tracks, and the like. The data processing system 100 comprises a content manager 102 that manages a content database 104 and includes a content database initialization or creation utility 106 and a content database search utility 108. The content database initialization utility 106 creates a content database 104 by assigning one or more tags 110 that represents context of the content to content and combines the tag or tags 110 with associated content 112 in a data structure 114, and saves the data structure in a database. The content database search utility 108 specifies a set of tag values representing context of content 112 and initiates a database query for determining a set of content items that match the specified set of tag values. The content database search utility 108 searches for the set of content items that match the tag values.

In some embodiments, the content database search utility 108 can be configured to receive a create content album command from a user 116 that specifies an album name and a set of tag values and respond by performing a database query. The content database search utility 108 compiles a list of content items resulting from the database query and saves the database query as at least part of a content album definition.

The content database search utility 108 can also be configured to receive an open content album command from a user 116 that specifies the album name and respond by opening a specified content album, accessing the saved database query for the specified content album, and determining content items included in the specified content album based on the database query.

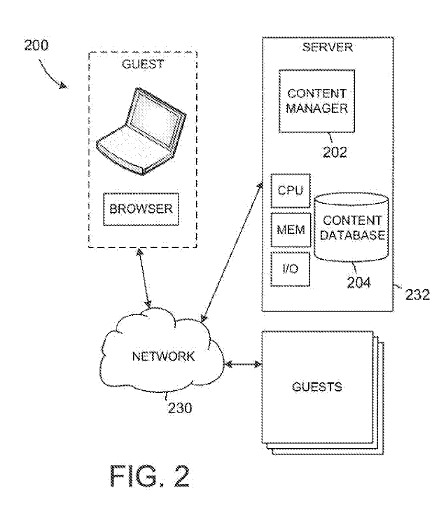

Referring to FIG. 2, a schematic block diagram depicts an embodiment of a network system 200 that supports content organization. The illustrative network system 200 comprises a network 230 and a server 232 coupled to the network 230 that is configured to run a content manager 202. The content manager 202 is configured to create and sort a content database 204 via network and local access.

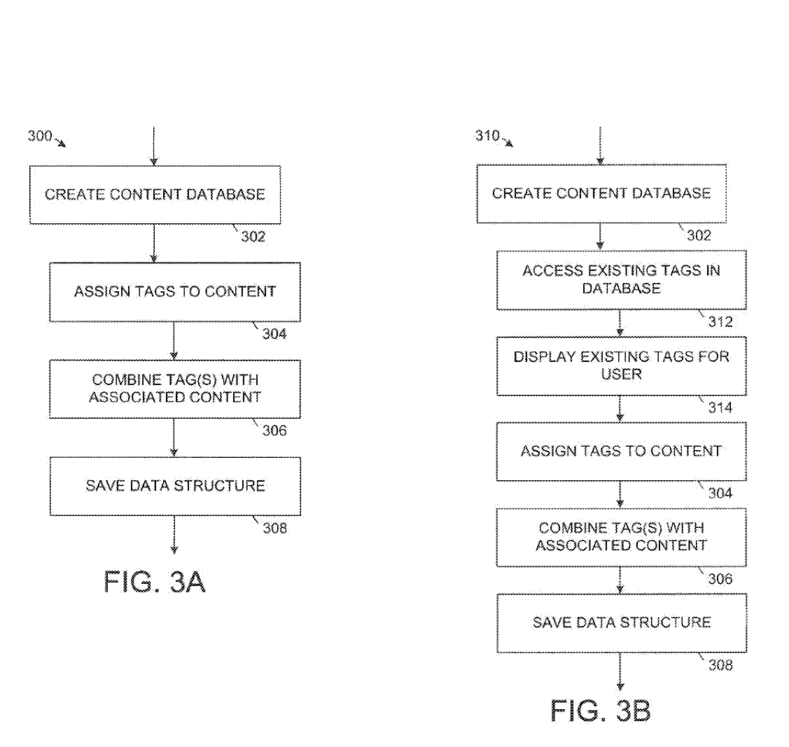

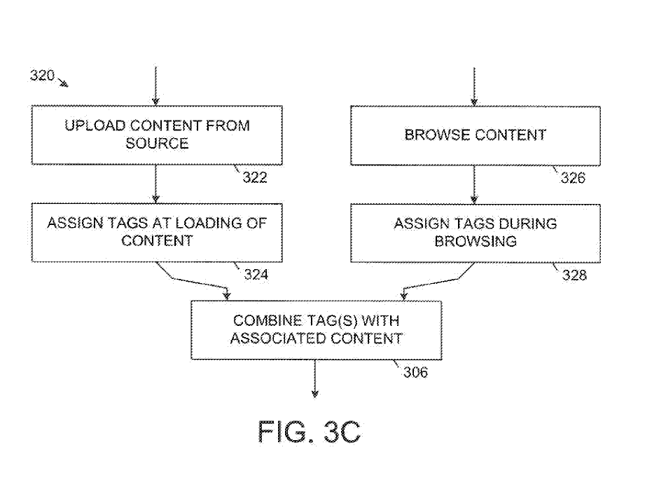

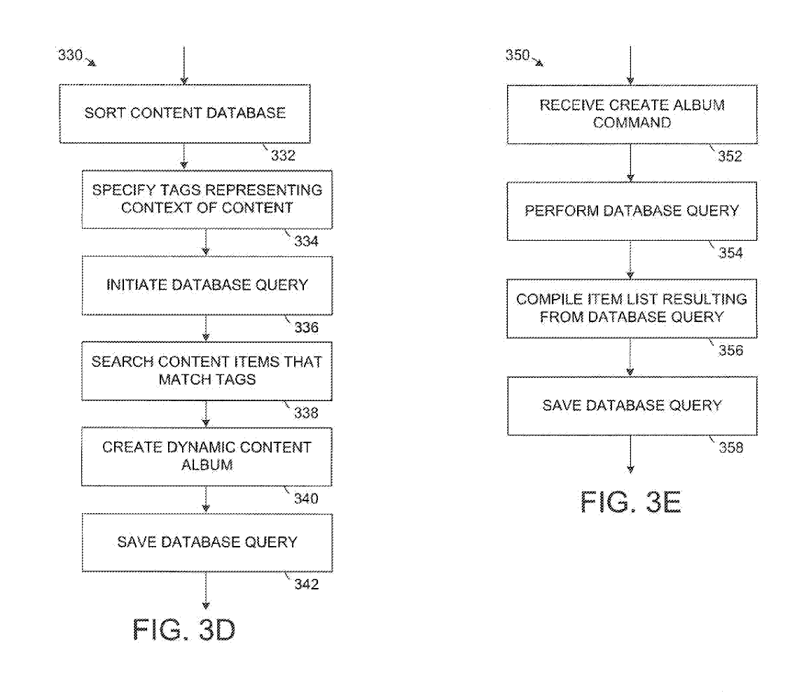

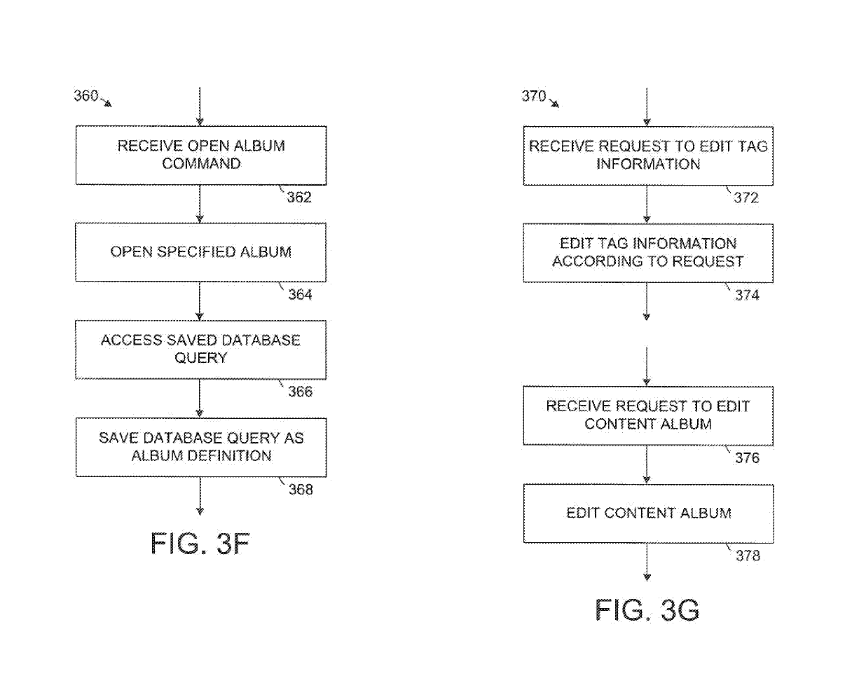

Referring to FIGS. 3A through 3G, flow charts illustrate one or more embodiments or aspects of a computer-executed method for managing content. FIG. 3A depicts a computer-executed method 300 for creating 302 a content database. The content database is created 302 by assigning 304 to content one or more tags that represent context of the content and combining 306 the tag(s) with associated content in a data structure. The data structure is saved 308 in a database.

Content can be in the form of digital photographs, video data, audio data, documents, emails, business letters and papers, and other types of data.

The tags can be assigned 304 by selectively combining specified tag values with logical inclusive and logical exclusive operators such as logical-OR and logical-AND functions.

The tags can be various text labels assigned values that are system-defined or user-defined. The tags can also include name/value pairs with the name being system-defined or user-defined. An example of a user-define tag can be defined as “Date Taken=Dec. 23, 2007”, a type of tag that enables more complex expressions such as relative comparisons, for example using the logical-OR or logical-AND functions (Date Taken<“Jan. 1, 2005”). The tag that is stored has an absolute value. The database query used to build an album may have a relative expression.

Tags that already are present in the content database can be determined for subsequent tagging of newly added content or modification of tags assigned to previously present content. Referring to FIG. 3B, a method 310 can further comprise accessing 312 existing tags stored in the database in association with content and displaying 314 the existing tags for user viewing.

Tags can be assigned to content at any time under user discretion. For example, referring to FIG. 3C, a method 320 can comprise uploading 322 the content from a source and assigning 324 the tags at the time the content is uploaded. In other occasions, the method 320 can comprise browsing 326 the content and assigning 328 the tags during browsing.

Referring to FIG. 3D, once the content database is created 302, a method 330 can comprise sorting 332 the content database. The content database can be sorted 332 by specifying 334 a set of tag values representing context of content and initiating 336 a database query for determining a set of content items that match the specified set of tag values. The method 330 further comprises searching 338 for the set of content items that match the tag values.

A dynamic content album can be created 340 by saving 342 the database query as at least part of a content album definition.

Referring to FIG. 3E, a computer-executed method 350 for creating a content album comprises receiving 352 a create content album command from a user that specifies an album name and an expression based on a set of tag values, performing 354 a database query, and compiling 356 a list of content items resulting from the database query. The database query can be saved 358 as at least part of a content album definition.

Referring to FIG. 3F, a computer-executed method 360 for opening a previously-existing content album comprises receiving 362 an open content album command from a user that specifies the album name and opening 364 the specified content album. The method 360 further comprises accessing 366 the saved data base query for the specified content album and determining 368 which content items are included in the specified content album based on the data base query.

The illustrative system and operating method enable a user to perform various editing operations. Referring to FIG. 3G, a method 370 for editing tag information comprises receiving 372 a request to edit tag information for an identified content item wherein tag information edits comprise add, delete, and modify operations. The tag information for the identified content item is edited 374 according to the request.

The method 370 can further comprise receiving 376 a request to edit a content album wherein content album edits comprise modification of tag specification, extend content set, and filter content set operations. The content album is edited 378 according to the request.

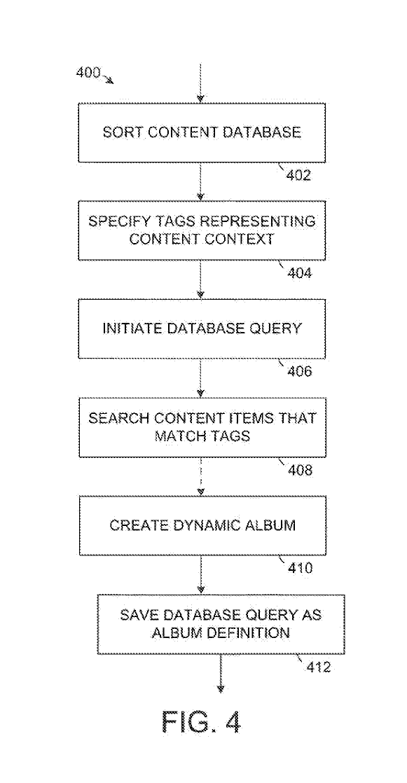

Referring to FIG. 4, a flow chart illustrates an embodiment or aspect of a computer-executed method for managing content. FIG. 4 depicts a content management method 400 that sorts 402 a content database. Sorting 402 the content database comprises specifying 404 a set of tag values representing context of content and initiating 406 a database query for determining a set of content items that match the specified set of tag values. The method 400 further comprises searching 408 for the set of content items that match the tag values.

A dynamic content album can be created 410 by saving 412 the database query as at least part of a content album definition.

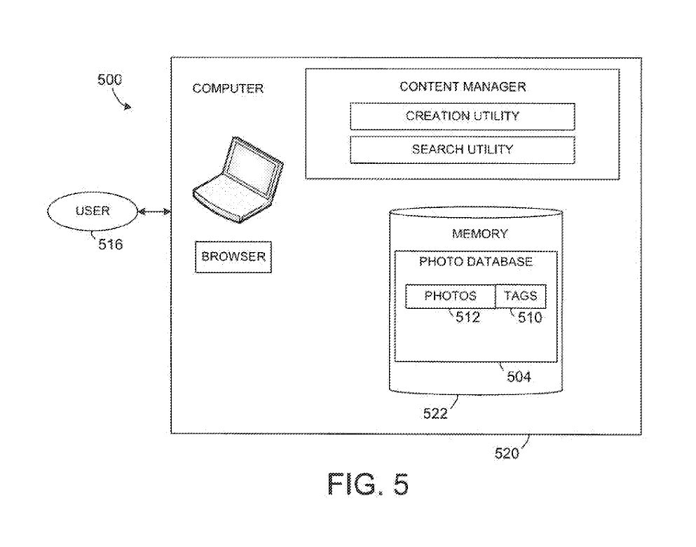

Referring to FIG. 5, a schematic block diagram depicts an embodiment of a photograph management system 500 that enables sorting of digital photographs using dynamic tags. A user 516 associates tags 510 with photographs 512. The tags 510 can be text labels that can be defined by the user for personal usage. Examples include classifications such as “family”, “Hawaii”, “Uncle Jim”, or the like. Each photograph 512 may have any number of associated tags 510. The tags 510 represent the context of the photograph 512. Typically, the user 516 assigns the tags 510 as the user uploads pictures to their computer 520 but can also assign tags 510 while browsing the photographs 512 at any time. A management application 506 allocates space, for example in memory 522, to add tags 510 and enables the user 516 to view which existing tags 510 are defined from past usage. The set of tag values can be saved in a database 504, associating the tags 510 with a particular photograph 512.

Later, the user 516 can perform a search operation by specifying a set of tag values (which can be inclusive with ORed tags, or exclusive with ANDed tags), initiating a database query which finds a set of photographs that have a matching set of tags. The search and collection of photographs can be used transiently, for example to narrow a search for a specific picture. The search and collection of photographs can also be used to create a new, dynamic photo album by saving the query as part of the photograph album definition.

Similarly, the user 516 can perform a “create photo album” operation. As part of the process, the user 516 assigns a name to the album and specifies a set of tag values. Creating the photo album involves performing a database query to obtain a selected list of appropriate photographs and saving the query as part of the photograph album definition.

Each time the user 516 opens a dynamic photograph album, the contents are calculated based on the database query. Therefore, for example, new photographs which are tagged “family” are automatically entered in the Family photograph album.

The illustrative photograph management system 500 enables the user 516 to edit existing photographs 512 at any time to add, remove, or edit tag information. Existing photo albums may also be edited to modify their tag specification, to extend or filter the set of included photos.

For an example, when uploading a photograph 512, the user 516 may tag the photograph 512 with the following list of tags including “Family”, “German vacation”, “2006”, “Bamberg”, “Malcolm”, “Susan”, and “funny” tags. The photograph 512 is thus automatically and dynamically entered in multiple photograph albums which were previously created by the user or other authorized parties including:
Family album: Tag=“Family”
2006 Highlights: Tag=“Family” AND “2006”
That's my boy: Tag=“Malcolm” AND “funny”
European travel: Tag=“German vacation” OR “Belgian beer festival” OR “Paris trip”.

The illustrative system and approach improves efficiency and enables extended photograph album functionality by introducing dynamic functionality and increased flexibility. Dynamic photograph albums automatically obtain appropriate pictures, thereby saving the user substantial management labor.

The illustrative system and method enable association of a context for photographs and also enables a meaningful way for the user to search their photograph collection. The illustrative tag technique imposes slight burden on system resources and is simple to implement highly flexible from the user's perspective. The user can choose contextual keys that make sense to user objectives, desires, and goals.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

The block diagrams and flow charts further describe an article of manufacture comprising a controller-usable medium having a computer readable program code embodied in a controller for organizing content into albums by tagging, and modeling context of photographic content.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A computer-executed method for managing content comprising:
creating a content database comprising:
assigning to content at least one tag that represents context of the content;
combining the at least one tag with associated content in a data structure; and
saving the data structure in a database.

2. The method according to claim 1 further comprising:
accessing existing tags stored in the database in association with content; and
displaying the existing tags for user viewing.

3. The method according to claim 1 further comprising:
uploading the content from a source; and
assigning the at least one tag at content upload.

4. The method according to claim 1 further comprising:
browsing the content; and
assigning the at least one tag during browsing.

5. The method according to claim 1 further comprising:
sorting the content database comprising:
specifying a set of tag values representing context of content;
initiating a database query for determining a set of content items that match the specified set of tag values; and
searching for the set of content items that match the tag values.

6. The method according to claim 5 further comprising:
creating a dynamic content album comprising saving the database query as at least part of a content album definition.

7. The method according to claim 5 further comprising:
receiving a create content album command from a user that specifies an album name and an expression based on a set of tag values;
performing a database query;
compiling a list of content items resulting from the database query; and
saving the database query as at least part of a content album definition.

8. The method according to claim 5 further comprising:
receiving an open content album command from a user that specifies the album name;
opening a specified content album;
accessing the saved database query for the specified content album; and
determining content items included in the specified content album based on the database query.

9. The method according to claim 1 further comprising:
selectively combining the specified tag values with logical inclusive and logical exclusive operators.

10. The method according to claim 1 further comprising:
the at least one tag comprising at least text label selected from a group consisting of system-defined text labels, user-defined text labels, system-defined name/value pairs, and user-defined name/values pairs.

11. The method according to claim 1 further comprising:
receiving a request to edit tag information for an identified content item wherein tag information edits comprise add, delete, and modify operations; and
editing the tag information for the identified content item according to the request.

12. The method according to claim 1 further comprising:
receiving a request to edit a content album wherein content album edits comprise modification of tag specification, extend content set, and filter content set operations; and
editing the content album according to the request.

13. The method according to claim 1 further comprising:
the content comprising at least one item selected from a group consisting of digital photographs, video data, audio data, documents, emails, business letters and papers, and other types of data.

14. A computer-executed method for managing content comprising:
sorting a content database comprising:
specifying a set of tag values representing context of content;
initiating a database query for determining a set of content items that match the specified set of tag values; and
searching for the set of content items that match the tag values.

15. The method according to claim 14 further comprising:
creating a dynamic content album comprising saving the database query as at least part of a content album definition.

16. The method according to claim 14 further comprising:
receiving a create content album command from a user that specifies an album name and a set of tag values;
performing a database query; compiling a list of content items resulting from the database query; and
saving the database query as at least part of a content album definition.

17. The method according to claim 14 further comprising:
receiving an open content album command from a user that specifies the album name;
opening a specified content album;
accessing the saved database query for the specified content album; and
determining content items included in the specified content album based on the database query.

18. A data processing system comprising:
a content manager that manages a content database comprising:
a content database initialization utility that creates a content database by assigning at least one tag that represents context of the content to content, combines the at least one tag with associated content in a data structure, and saves the data structure in a database; and
a content database search utility that specifies a set of tag values representing context of content, initiates a database query for determining a set of content items that match the specified set of tag values, and searches for the set of content items that match the tag values.

19. The system according to claim 18 further comprising:
the content database search utility further configured to receive a create content album command from a user that specifies an album name and a set of tag values and respond by performing a database query, compiling a list of content items resulting from the database query, and saving the database query as at least part of a content album definition; and
the content database search utility further configured to receive an open content album command from a user that specifies the album name and respond by opening a specified content album, accessing the saved database query for the specified content album, and determining content items included in the specified content album based on the database query.

20. The system according to claim 18 further comprising:
a network;
a server coupled to the network and configured to run the content manager; and
the content manager configured to create and sort a content database via network and local access.
